(19) United States
(12) Patent Application Publication
(10) Pub. No.: US 2025/0225617 A1
(43) Pub. Date: Jul. 10, 2025

(54) METHOD FOR ADVANCED IMAGE PROCESSING USING PHYSICS-INFORMED LEARNING FOR ARTIFICIAL INTELLIGENCE-BASED APPLICATIONS

(71) Applicant: Samsung Electronics Co., Ltd., Suwon-si (KR)

(72) Inventors: Priyadarshini Panemangalore PAI, Suwon-si (KR); Shubham Sambhaji PATIL, Suwon-si (KR); Prashant Pandurang SHINDE, Suwon-si (KR); Shashishekara Parampalli ADIGA, Suwon-si (KR)

(73) Assignee: Samsung Electronics Co., Ltd., Suwon-si (KR)

(21) Appl. No.: 19/016,393

(22) Filed: Jan. 10, 2025

(30) Foreign Application Priority Data
Jan. 10, 2024 (IN) 202441001922
Jan. 9, 2025 (KR) 10-2025-0003675

(51) Int. Cl. G06T 3/4053; G06T 5/70; G06V 10/42; G06V 10/54; G06V 10/60

(52) U.S. Cl. CPC G06T 3/4053; G06T 5/70; G06V 10/431; G06V 10/54; G06V 10/60

(57) ABSTRACT

Disclosed is a method for advanced image processing using physics-informed learning for artificial intelligence (AI) based applications using a Physics Informed Neural Operator Based Learning (PINOBL) model in semiconductor manufacturing. The method includes determining a attributes based on functional units associated with input images. The method also includes selecting, based on the set of attributes, a set of physics-based mathematical solvers corresponding to an image-processing task. The method also includes generating according to the set of physics-based mathematical solvers, a set of intermediate images corresponding to the set of input images.

### CROSS-REFERENCE TO RELATED APPLICATION

This application claims priority to and the benefit of Indian Patent Application number 202441001922 filed in the Indian Intellectual Property Office on Jan. 10, 2024, and Korean Patent Application No. 10-2025-0003675 filed in the Korean Intellectual Property Office on Jan. 9, 2025, the entire contents of which are incorporated herein by reference.

### BACKGROUND OF THE INVENTION

### 1. Field

The present disclosure relates to image processing and more particularly, relates to a method for advanced image processing using physics-informed learning for artificial intelligence (AI) based applications in semiconductor manufacturing.

### 2. Description of the Related Art

The demand for image processing models necessitates extensive volumes of training data. However, the sensitive nature of semiconductor wafer data presents challenges in acquiring high-quality, diverse, and representative data for training purposes. Nevertheless, current technology allows for the development of artificial intelligence (AI) based methods to address this issue.

AI is increasingly being integrated into semiconductor manufacturing pipelines to enhance product quality and streamline production time and costs. This integration is particularly evident in the context of wafer defect inspection. Data from various stages of the manufacturing pipeline are leveraged for model development. For instance, consider a semiconductor manufacturing facility where scanning electron microscopy is used to capture images of semiconductor wafers at different stages of production. The images contain critical information about defects, patterns, and other quality-related features. Conventional methods for developing image processing models for defect detection would involve accumulating a vast dataset of annotated images for training the models effectively. However, due to the sensitive nature of the data and the need for diverse representations, obtaining such a comprehensive dataset can be challenging.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

In one general aspect, a method for processing an image using a Physics Informed Neural Operator Based Learning (PINOBL) model includes: receiving input images and an indication of an image-processing task to be performed on the input images, the image-processing task among a set of image-processing tasks the PINOBL model is configured to perform; determining attributes based functional units associated with the input images; selecting, based on the attributes, physics-based mathematical solvers corresponding to the image-processing task; generating intermediate images respectively corresponding to the input images, the PINOBL model being associated with the physics-based mathematical solvers; computing a residual loss based on a comparison between the attributes of the intermediate images and solver parameters associated with the physics-based mathematical solvers; regenerating, using the PINOBL model, the intermediate images based on back-propagation of the computed residual loss until convergence of the attributes with the solver parameters; and upon the convergence of the attributes with the solver parameters, generating, using the PINOBL model, a final image outputs relating to the image-processing task based on the input images and the intermediate images.

The attributes may correspond to a pixel value and temporal information of each of the input images.

The image processing task among may be either super-resolution or denoising.

The attributes may include a brightness value, a contrast, and/or a texture of the input images.

The selecting of the physics-based mathematical solvers may include: identifying a physics-based laws governing the image-processing task; selecting a physics-based mathematical equations corresponding to the identified physics-based laws; and constructing a set-up based on the selected physics-based mathematical equations for the input images and based on intermediate image-based substitution, and assessing compliance with the identified physics-based laws.

The determining of the attributes based on the functional units may include: selecting a functional unit among the functional units based on the image-processing task; determining, using the selected functional unit, application-specific images respectively corresponding the input images; and determining the attributes based on the application-specific image corresponding to each of the input images.

The functional unit may be selected from any one of: a collection of a uniform grid; or a probability distribution or domain-knowledge/physics-aware sampling.

The generating of the intermediate images may include: acquiring attribute values of a selected functional unit of the functional units extracted from at an input image of the input images; projecting the attribute values on a multi-dimensional space; and performing physics-informed mathematical transformations on the attribute values based on the constructed set-up to generate the intermediate images.

The set-up to generate the intermediate images may include functional blocks with neural network layers.

The functional blocks may include a fully connected layer block and a Fourier block with a skip connection.

The Fourier block may include: a functional unit configured to transform features extracted from the input images in the frequency domain; generating a domain-knowledge based frequency selector for selecting information related to frequencies of interest based on the indication of the image processing task; selecting and processing the frequencies of interest from the input image using the domain-knowledge based frequency selector; and outputting an inverse-transformed image by performing inverse-transformations to obtain features in the physical domain from the frequency domain.

The computing of the residual loss may include: calculating, using an automatic differentiation (AD), differential terms to construct the physics-based laws; determining a residue based on determined compliance of attributes of the functional units with the physics-based laws governing the image-processing task; forming a residue-based loss function based on the determined residue; and computing, using the residue-based loss function, a residual loss pertaining to non-compliance of intermediate values of attributes of the representative functional units with physics-based laws governing the image-processing task.

In another general aspect, a system for image processing using a Physics Informed Neural Operator Based Learning (PINOBL) model includes: one or more processors; and a memory storing instructions configured to cause the one or more processors to perform a process including: receiving input images and an image-processing task to be performed on the input images, the image-processing task among a set of image-processing tasks the PINOBL model is configured to perform; determining attributes based on functional units associated with the input images; selecting, based on the attributes, physics-based mathematical solvers corresponding to the image-processing task; generating intermediate images respectively corresponding to the input images, the PINOBL model being associated with the physics-based mathematical solvers; computing a residual loss based on a comparison between the attributes of the intermediate images and solver parameters associated with the physics-based mathematical solvers; regenerating the intermediate images based on back-propagation of the computed residual loss until convergence of the attributes with the solver parameters; and upon convergence of the attributes with the solver parameters, generating final image outputs relating to the image-processing task based on the input images and the intermediate images.

The attributes may correspond to a pixel value and temporal information of each of the input images.

The indicated image processing task may be super-resolution or denoising.

The attributes may include a brightness value, a contrast, and/or a texture of the input images.

The selecting of the physics-based mathematical solvers may include: identifying a physics-based laws governing the image-processing task; selecting physics-based mathematical equations corresponding to the identified physics-based laws; and constructing a set-up based on the selected physics-based mathematical equations for the input images and based on intermediate image-based substitution, and assessing compliance with the identified physics-based laws.

The determining of the attributes based on the functional units may include: selecting a functional unit among the functional units based on the indication of the image-processing task; determining, using the selected functional unit, application-specific images respectively corresponding to the input images; and determining the attributes based on the application-specific image corresponding to each of the input images.

The functional unit may be selected from available functional units of the PINOBL model, the available functional units including: a collection of a uniform grid; or a probability distribution or domain-knowledge/physics-aware sampling.

The generating of the intermediate images may include: acquiring attribute values of a selected functional unit of the functional units extracted from at least one input image of the input images; projecting the attribute values on a high-dimensional space; and performing physics-informed mathematical transformations on the attribute values based on the constructed set-up to generate the intermediate images.

The set-up to generate the intermediate images may include functional blocks with neural network layers.

The functional blocks may include at least one fully connected layer block and a Fourier block with a skip connection.

The Fourier block may include a functional unit configured to transform features extracted from the input images in the frequency domain; and wherein the process further includes: generating a domain-knowledge based frequency selector for selecting information related to frequencies of interest based on the image processing task; selecting and processing the frequencies of interest from the input images using the domain-knowledge based frequency selector; outputting an inverse-transformed image by performing inverse transformations to obtain features in the physical domain from the frequency domain.

The computing of the residual loss may include: calculating, using an automatic differentiation (AD), differential terms to construct the physics-based laws governing the image-processing task; determining a residue based on determined compliance of attributes of the functional units with the physics-based laws governing the at least one image-processing task; forming a residue-based loss function based on the determined residue; and computing, using the residue-based loss function, the residual loss pertaining to the non-compliance of intermediate values of attributes of the representative functional units with physics-based laws governing the image-processing task.

Other features and aspects will be apparent from the following detailed description, the drawings, and the claims.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a system architecture, according to one or more embodiments;

FIG. 2 illustrates the architecture of a Physics Informed Neural Operator Based Learning (PINOBL) Model, according to one or more embodiments;

FIG. 3 illustrates the working of a functional unit collector of the PINOBL model, according to one or more embodiments;

FIG. 4 illustrates the working of a physics-aware neural network based functional layers of the PINOBL model, according to one or more embodiments;

FIG. 5 illustrates the working of a differential equation generator of the PINOBL model, according to one or more embodiments;

FIG. 6 illustrates the working of an analyzer and a differential equation based loss calculator of the PINOBL model, according to one or more embodiments; and

FIG. 7 illustrates the working of the PINOBL model, according to one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

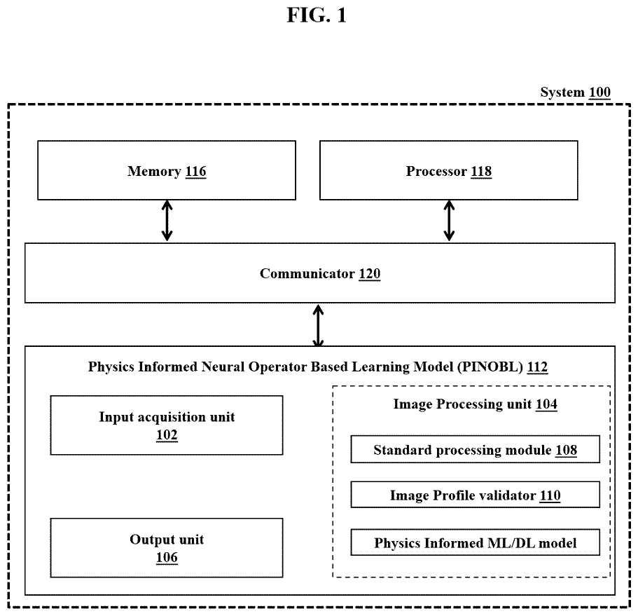

FIG. 1 illustrates a system architecture 100, according to one or more embodiments. The system 100 may be an image processing system. The system 100 may include a memory 116, a processor 118, a communicator 120, and a Physics Informed Neural Operator Based Learning (PINOBL) Model 112. The system 100 may be implemented on one or multiple image processing systems.

The memory 116 may store instructions to be executed by the processor 118 for image processing in the system 100. The memory 116 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 116 may, in some examples, be considered a non-transitory storage medium (which is not embodied in a carrier wave or a propagated signal). A non-transitory storage medium may store data that can, over time, change (e.g., in Random Access Memory (RAM) or cache). The memory 116 may be an internal storage unit, an external storage unit of the system 100, a cloud storage, and/or any other type of external storage.

The processor 118 may communicate with the memory 116, the communicator 120, and the PINOBL model 112. The processor 118 may be configured to execute instructions stored in the memory 116 and to perform various processes for processing images input to the system 100, as described herein. Source code may be prepared in a manner analogous to the descriptions herein, and code/instructions compiled therefrom may be executed by the processor 118. The processor 118 may include one or a plurality of processors, and may be a general-purpose processor, such as a central processing unit (CPU), an application processor (AP), and/or the like, a graphics-only processing unit such as a graphics processing unit (GPU), a visual processing unit (VPU), and/or an Artificial intelligence (AI) dedicated processor such as a neural processing unit (NPU).

The processor 118 may be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the PINOBL model 112 may be implemented as functional modules used for image processing (the modules may be discrete units of instructions, for example, library modules, or the like). The PINOBL model 112 may include but is not limited to an input acquisition unit 102, an image processing unit 104, and an output unit 106. The input acquisition unit 102 may be used to take/acquire an image as an input along with an indication of an intended application/task (e.g., super-resolution/de-noising/etc.) for advanced processing. Further, the image processing unit 104, may be used to process the image received by the input acquisition unit 102 using a set of modules. In FIG. 1, the set of modules may include a standard processing module 108 and an image profile validator 110. The standard processing module 108 may enable a dimension modification (resizing) of the image received by the input acquisition unit 102 for example by performing interpolation, etc. The image profile validator 110 may check suitability of the parameters of the input images for a specific application of interest. The PINOBL model 112 may be a Machine Learning (ML) or a Deep Learning (DL) model (e.g., a neural network), which utilizes learned domain knowledge and performs a desired image processing task based on laws of physics. The output unit 106 may render the processed image to a user using a predefined interface (e.g., displaying the output image, storing the output image to storage, etc.).

In one or more embodiments, the PINOBL model 112 may employ a dual approach that integrates both data-driven and equation-based loss functions, utilizing all available resources for operator learning across a broad spectrum of applications involving solving differential equations governed by laws of physics. This architecture not only excels in conventional learning frameworks but also demonstrates exceptional proficiency in zero-shot learning scenarios.

Additionally, the PINOBL model 112 may address the complexities associated with nonlinear partial differential equations, such as those represented by Burger's equation, thereby enhancing the modeling of fluid dynamics. Furthermore, the PINOBL model 112 may significantly accelerate and optimize the design of composite material processes, improving efficiency and reducing computational overhead. Collectively, these capabilities position the PINOBL model 112 as a pivotal advancement in the convergence of machine learning and physics, providing robust solutions to complex engineering and scientific challenges.

The PINOBL model 112 model may be operably connected to (or implemented by) the memory 116 and the processor 118 and may be configured to receive a set of input images, and an indication of an image-processing task to be performed among a set of image-processing tasks on the set of input images.

Further, the PINOBL model 112 may determine a set of attributes based on one or more functional units associated with the set of input images. The set of attributes may be a pixel value and a temporal information of each of the input images. The temporal information may include of a brightness value, a contrast, and/or a texture of the set of input images. The determination of the set of attributes may include selecting a functional unit among the one or more functional units based on the image-processing task and functionality. Further, the determination of the set of attributes may include determining, using the selected functional unit, an application-specific image corresponding to each of the input images. Moreover, the set of attributes may be determined based on the application-specific image corresponding to each of the input images. The functional unit may be selected from one of functions including a collection of a uniform grid, a probability distribution, or a domain-knowledge/physics-aware sampling.

Moreover, the PINOBL model 112 may select, based on the set of attributes, a set of physics-based mathematical solvers corresponding to the image-processing task. The selection of the set of physics-based mathematical solvers may include identifying the set of physics-based laws governing the image-processing task from among the set of image-processing tasks. Further, the selection of the set of physics-based mathematical solvers may include selecting the set of physics-based mathematical equations corresponding to the identified physics-based laws governing the image-processing task that is to be performed on the set of input images. Moreover, the selection of the set of physics-based mathematical solvers may include (i) constructing a set-up based on the selected set of physics-based mathematical equations for the input images and based on intermediate image-based substitution and (ii) assessing compliance with the identified physics-based laws.

Furthermore, the PINOBL model 112 may generate a set of intermediate images corresponding to the set of input images. In the generation of the set of intermediate images, the PINOBL model 112 may be configured to acquire attribute values of a selected functional unit (or possibly more) of the functional units extracted from at least one input image of the set of input images. Further, the PINOBL model 112 may be configured to project the attribute values on a high-dimensional space. Moreover, the PINOBL model 112 may be configured to perform physics-informed mathematical transformations on the attribute values based on the constructed set-up to generate the set of intermediate images. The generation of the set of intermediate images may be performed by a set of functional blocks with neural network layers. Further, the functional blocks may include at least one fully connected layer block and a Fourier block with skip connections. Moreover, the Fourier blocks may include a functional unit to transform features extracted from the set of input images in the frequency domain. Further, the Fourier blocks may include generating a domain-knowledge-based frequency selector for selecting information related to frequencies of interest based on the indicated image processing task. Furthermore, the Fourier blocks may include blocks for selecting and processing the frequencies of interest from the input using the domain-knowledge-based frequency selector. The Fourier blocks also may include a block for performing inverse transformations to obtain features in the physical domain from the frequency domain and outputting the resulting image. The Fourier blocks may be used to acquire knowledge of a frequency domain of the set of input images.

The PINOBL model 112 also may compute a residual loss based on a comparison between the set of attributes of the set of intermediate images and a set of solver parameters associated with the set of physics-based mathematical solvers. The computation of residual loss may include calculating, using an automatic differentiation (AD), differential terms to construct the physics-based laws governing the image-processing task. Further, the computation of residual loss may include determining a residue (or loss) based on the compliance of attributes of the one or more functional units with the physics-based laws governing the image-processing task. Moreover, the computation of residual loss may include forming a residue-based loss function based on the determined residue. Furthermore, the computation of residual loss may include computing, using the residue-based loss function, the residual loss pertaining to non-compliance of intermediate values of attributes of the representative functional units with physics-based laws governing the image-processing task. The residual loss may connect the neural network approximation to the partial differential equation PDE and may also measure the residues, which are differences between observed values and predicted values of data in a statistical or machine learning model. The residual loss may be a diagnostic measure used for assessing a quality of a AI model. The residual loss may also be referred to as an error. In some embodiments, the PINOBL model 112 may start learning from a value that may or may not be accurate when training the system 100 by solving the differential equations, and by updating/modifying parameters in the PINOBL model 112 to minimize the residues depending on whether the governing physical laws are satisfied or complied with. Further, the PINOBL model 112 may regenerate the set of intermediate images by performing back-propagation based on the computed residual loss until convergence of the set of attributes with the set of solver parameters.

Moreover, upon the convergence of the set of attributes with the set of solver parameters, the PINOBL model 112 may generate a set of final image outputs relating to the image-processing task based on the set of input images and the set of intermediate images.

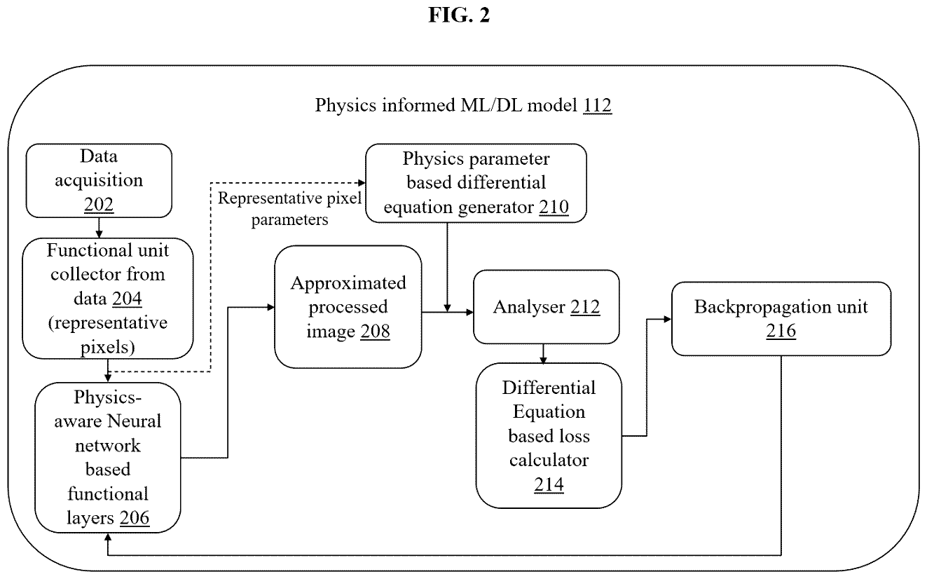

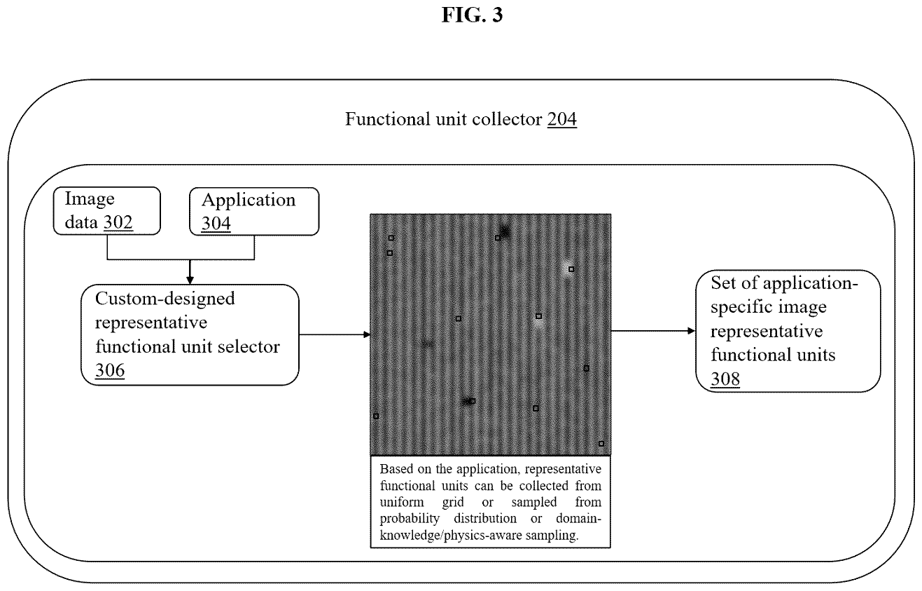

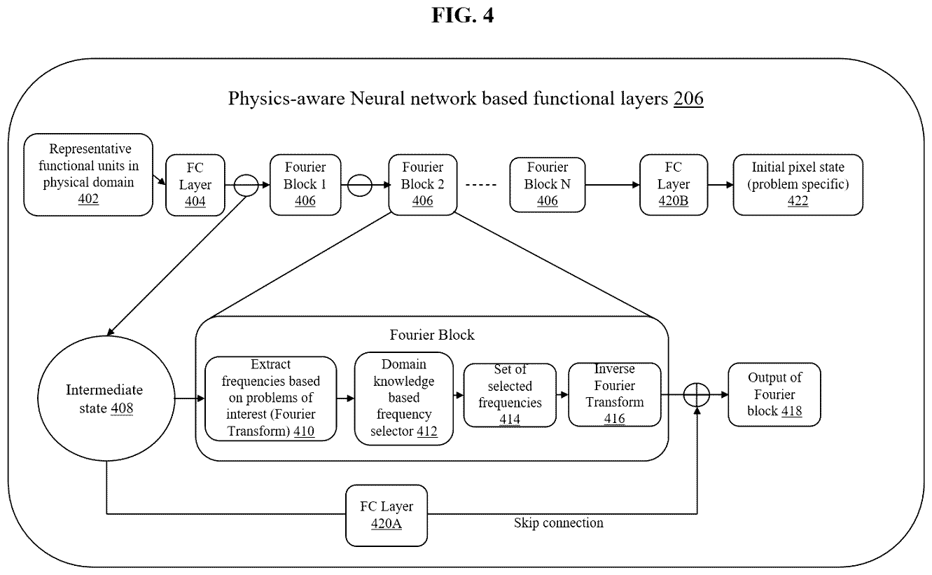

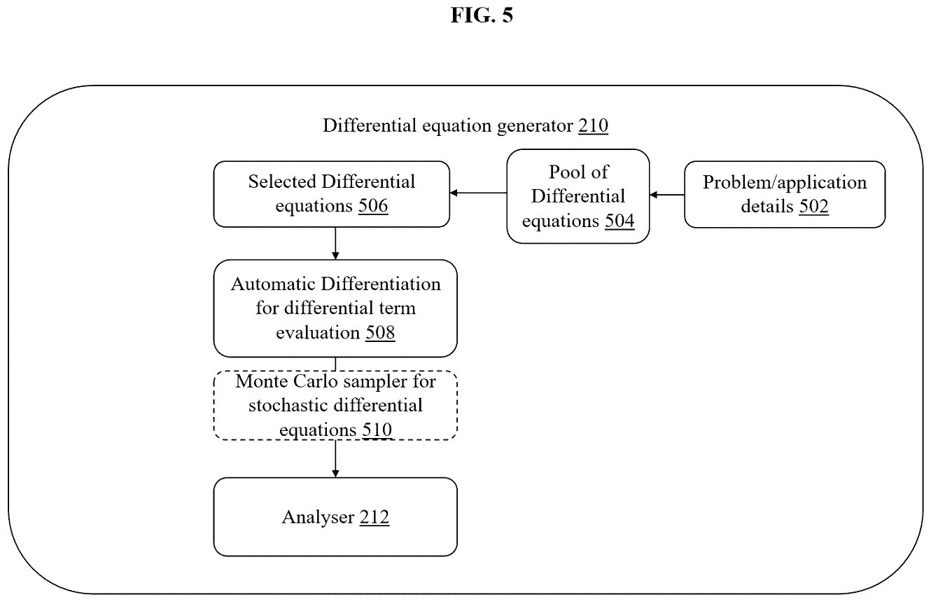

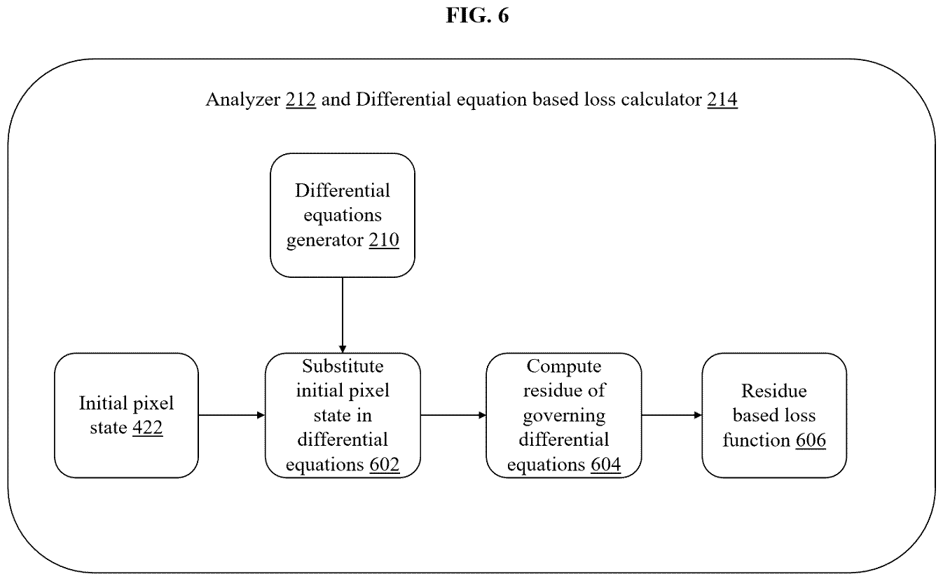

FIG. 2 illustrates the architecture of the PINOBL model 112 according to one or more embodiments. FIG. 3 illustrates the working of a functional unit collector 204 of the PINOBL model 112 according to one or more embodiments. FIG. 4 illustrates the working of a physics-aware neural network-based functional layers 206 of the PINOBL model 112 according to one or more embodiments. FIG. 5 illustrates the working of a differential equation generator 210 of the PINOBL model 112 according to one or more embodiments. FIG. 6 illustrates the working of an analyzer 212 and a differential equation-based loss calculator 214 of the PINOBL model 112 according to one or more embodiments. FIG. 2 to FIG. 6 are explained together next.

Referring to FIG. 2, the PINOBL model 112 may be a Machine Learning (ML)/Deep Learning (DL) model that is used for executing the tasks assigned for image processing and may do so based on the governing physics laws. The PINOBL model 112 may include but is not limited to a data acquisition unit 202, a functional unit collector 204, a physics-aware neural network-based functional layers 206, an approximated processed image 208, a physics parameter-based differential equation generator 210, an analyzer 212, a differential equation based loss calculator 214, and a backpropagation unit 216. The data acquisition unit 202 may receive a set of input images and indications of a set of image processing tasks from the system 100 for performing image processing.

Referring to FIG. 2 and FIG. 3, the functional unit collector 204 may use the set of input images 302 and collect representative functional units from one or more functional units (pixel details) based on the application 304 of interest. Hence, a custom-designed representative functional unit selector 306 may be determined. The custom-designed representative functional unit selector 306 may be collected using representative functional units such as functional units for uniform grid sampling, sampling using probability density, or any other relevant physics-aware sampling method. Furthermore, a set of application-specific image representative functional units 308 may be determined.

Referring to FIG. 2 and FIG. 4, the physics-aware neural network-based functional layers 206 may use a Fourier Neural Operator (FNO) for operations. The FNO module may transform a selected representative functional unit 402 from a physical domain to a frequency domain and back. During such a transformation, application-based selection of frequencies may also be employed (e.g., bandpass filters). The selected representative functional units 402 may be shared with a first Fully Connected (FC) layer 404 for further processing. The first FC layer 404 may include Fourier Blocks 406. An intermediate state 408 may be provided for processing the set of input images 302 may be output by the FC layer 404. A first Fourier block 406, may be configured to extract 410 frequencies from the intermediate start 408 based on problems of interest (also referred to as Fourier transform). To that end, the first Fourier block 406, may be configured to select 412 a frequency selector based on the previously learned domain knowledge of the network. Accordingly, the first Fourier block 406 may select 414 a set of selected frequencies. The first Fourier block 406 may perform 416 inverse Fourier transform on the data of the selected frequencies to generate an output 418 of the first Fourier block 406. Moving further, a second FC layer 420A may be used to bypass the first Fourier block 406 (each Fourier block 406 may have it is own such bypass layer). An initial pixel state 422 which is problem-specific in nature may be generated as an output by a third FC layer 420B, and the approximated processed image 208, may be generated to form a basis of a physics-informed learning process.

Referring to FIG. 5, the physics parameter-based differential equation generator 210 (see FIG. 2) may select differential equations based on the application 304 and generate the differential terms for the physics-informed learning. Problems/application details 502 related to representative pixel parameters from the functional unit collector 204 may be received by the differential equation generator 210. The differential equation generator 210 may include a pool of differential equations 504 from which a suitable differential equation 506 may be selected (based on the problems/application details 502).

The differential equations generation process may be executed using automatic differentiation or finite difference method for a differential term evaluation 508. Additionally, a Monte Carlo sampler may be used to handle stochastic differential equations 510 (the optionality of stochastic differential equations 510 does not imply that any other components/blocks/modules are non-optional). The output of the sampler may be shared with the analyzer 212.

Referring to FIG. 6, the analyzer 212 (see FIG. 2) may check the approximated processed image's 208 (from the physics-aware neural network-based functional layers 206) compatibility with the selected differential equations 510 generated by the differential equation generator 210. The initial pixel state 422 may be substituted 602 into the output from the differential equations generator 210 in the differential equation-based loss calculator 214. A residue of the governing differential equation may then be computed 604 using the differential equation-based loss calculator 214. A residue-based loss function 606 may be generated by the differential equation-based loss calculator 214. The backpropagation unit 216 may compute the gradients of the loss function with respect to the parameters of the neural network and assist the learning process to achieve the desirable performance.

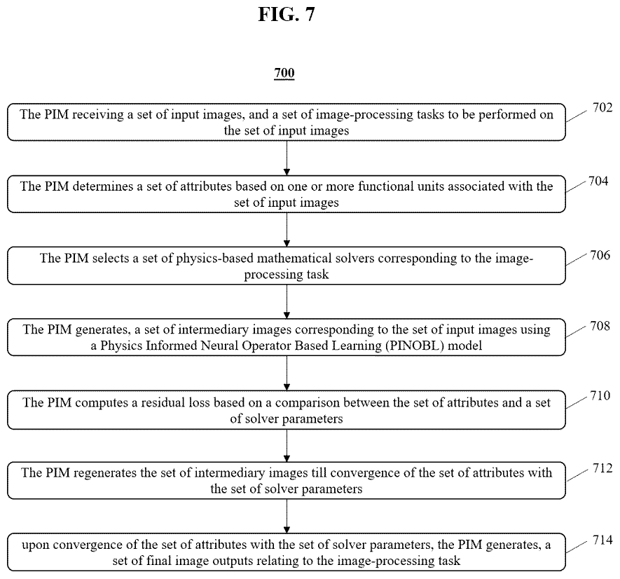

FIG. 7 illustrates the working method of the PINOBL model 112 according to one or more embodiments. The method 700 of the PINOBL model 112 generates a final processed image.

At step 702, the PINOBL model 112 may receive a set of input images 302 and an indication of an image-processing task to be performed (among a set of image-processing tasks) on the set of input images 302. The image processing task may be super-resolution or denoising, as non-limiting examples.

At step 704, the PINOBL model 112 may determine a set of attributes based on one or more functional units associated with the set of input images 302. The set of attributes may be a pixel value and temporal information of each image in the set of input images 302. The temporal information may include a brightness value, a contrast, and/or a texture of the set of input images 302. The determination of the set of attributes may include selecting a functional unit among the one or more functional units based on the image-processing task and functionality. Further, the determination of the set of attributes may include generating, using the selected functional unit, application-specific images respectively corresponding to the input images 302. Moreover, the set of attributes may be determined based on the application-specific images. The functional unit may be selected from among a uniform grid functional unit, a probability distribution functional unit, or a domain-knowledge/physics-aware sampling functional unit.

At step 706, the PINOBL model 112 may select, based on the set of attributes, a set of physics-based mathematical solvers corresponding to the image-processing task. The selection of the set of physics-based mathematical solvers may include identifying the set of physics-based laws governing the image-processing task to be performed. The set of physics-based mathematical equations as corresponding to the identified physics-based laws governing the image-processing task that is to be performed on the set of input images 302. Moreover, the selection of the set of physics-based mathematical solvers may include constructing a set-up based on the selected set of physics-based mathematical equations for input and intermediate image-based substitution and assessing compliance.

At step 708, the PINOBL model 112 may generate intermediate images respectively corresponding to the input images 302. In the generation of the intermediate images, the PINOBL model 112 may be configured to acquire attribute values of at least one selected functional unit (among the functional units) extracted from at least one input image of the set of input images 302. Further, the PINOBL model 112 may be configured to project the attribute values on a high-dimensional space. Moreover, the PINOBL model 112 may be configured to perform physics-informed mathematical transformations on the attribute values based on the constructed set-up to generate the intermediate images. The generation of the intermediate images may be performed by a set of functional blocks with neural network layers. Further, the functional blocks may include at least one fully connected layer block and a Fourier block with skip connections. Moreover, the Fourier blocks 406 may each include a functional unit to transform features extracted from the set of input images 302 in the frequency domain. Further, the Fourier blocks 406 may generate a domain-knowledge-based frequency selector for selecting information related to frequencies of interest based on the target image processing task. Furthermore, the Fourier blocks 406 may select and process the frequencies of interest from the input using the domain-knowledge-based frequency selector. The Fourier block also may perform inverse transformations to obtain features in the physical domain from the frequency domain and output the image.

At step 710, the PINOBL model 112 may compute a residual loss based on a comparison between the set of attributes of the set of intermediate images and a set of solver parameters associated with the set of physics-based mathematical solvers. The computation of residual loss may include calculating, using an automatic differentiation (AD), differential terms to construct the physics-based laws governing the image-processing task. The computation of residual loss may include determining a residue based on the compliance of attributes of the one or more functional units with the physics-based laws governing the image-processing task. The computation of residual loss may include forming a residue-based loss function based on the determined residue. The computation of residual loss may include computing, using the residue-based loss function, the residual loss pertaining to the non-compliance of intermediate values of attributes of the representative functional units with physics-based laws governing the at least one image-processing task.

At step 712, the PINOBL model 112 may regenerate the set of intermediate images based on back-propagation of the computed residual loss until convergence of the set of attributes with the set of solver parameters.

At step 714, upon the convergence of the set of attributes with the set of solver parameters, the PINOBL model 112 may generate a set of final image outputs relating to the image-processing task based on the set of input images 302 and the set of intermediate images.

The present disclosure presents various technical advantages. For example, the PINOBL model 112 may eliminate a need for large amounts of training data. Moreover, the PINOBL model 112 may be resource-efficient and may be adopted for a wide range of image heterogeneity.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the invention.

The computing apparatuses, the electronic devices, the processors, the memories, the information output system and hardware, the storage devices, and other apparatuses, devices, units, modules, and components described herein with respect to FIGS. 1-24 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-24 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method for processing an image using a Physics Informed Neural Operator Based Learning (PINOBL) model, the method comprising:
receiving input images and an indication of an image-processing task to be performed on the input images, the image-processing task among a set of image-processing tasks the PINOBL model is configured to perform;
determining attributes based functional units associated with the input images;
selecting, based on the attributes, physics-based mathematical solvers corresponding to the image-processing task;
generating intermediate images respectively corresponding to the input images, the PINOBL model being associated with the physics-based mathematical solvers;
computing a residual loss based on a comparison between the attributes of the intermediate images and solver parameters associated with the physics-based mathematical solvers;
regenerating, using the PINOBL model, the intermediate images based on back-propagation of the computed residual loss until convergence of the attributes with the solver parameters; and
upon the convergence of the attributes with the solver parameters, generating, using the PINOBL model, a final image outputs relating to the image-processing task based on the input images and the intermediate images.

2. The method of claim 1, wherein
the attributes corresponds to a pixel value and temporal information of each of the input images.

3. The method of claim 1, wherein
the image processing task among is either super-resolution or denoising.

4. The method of claim 1, wherein
the attributes comprise a brightness value, a contrast, and/or a texture of the input images.

5. The method of claim 1, wherein
the selecting of the physics-based mathematical solvers comprises:
identifying a physics-based laws governing the image-processing task;
selecting a physics-based mathematical equations corresponding to the identified physics-based laws; and
constructing a set-up based on the selected physics-based mathematical equations for the input images and based on intermediate image-based substitution, and assessing compliance with the identified physics-based laws.

6. The method of claim 1, wherein
the determining of the attributes based on the functional units comprises:
selecting a functional unit among the functional units based on the image-processing task;
determining, using the selected functional unit, application-specific images respectively corresponding the input images; and
determining the attributes based on the application-specific image corresponding to each of the input images.

7. The method of claim 6, wherein
the functional unit is selected from any one of:
a collection of a uniform grid; or
a probability distribution or domain-knowledge/physics-aware sampling.

8. The method of claim 5, wherein
the generating of the intermediate images comprises:
acquiring attribute values of a selected functional unit of the functional units extracted from at an input image of the input images;
projecting the attribute values on a multi-dimensional space; and
performing physics-informed mathematical transformations on the attribute values based on the constructed set-up to generate the intermediate images.

9. The method of claim 7, wherein
the Fourier block comprises:
a functional unit configured to transform features extracted from the input images in the frequency domain;
generating a domain-knowledge based frequency selector for selecting information related to frequencies of interest based on the indication of the image processing task;
selecting and processing the frequencies of interest from the input image using the domain-knowledge based frequency selector; and
outputting an inverse-transformed image by performing inverse-transformations to obtain features in the physical domain from the frequency domain.

10. The method of claim 5, wherein
the computing of the residual loss comprises:
calculating, using an automatic differentiation (AD), differential terms to construct the physics-based laws;
determining a residue based on determined compliance of attributes of the functional units with the physics-based laws governing the image-processing task;
forming a residue-based loss function based on the determined residue; and
computing, using the residue-based loss function, a residual loss pertaining to non-compliance of intermediate values of attributes of the representative functional units with physics-based laws governing the image-processing task.

11. A system for image processing using a Physics Informed Neural Operator Based Learning (PINOBL) model, the system comprising:
one or more processors; and
a memory storing instructions configured to cause the one or more processors to perform a process comprising:
receiving input images and an image-processing task to be performed on the input images, the image-processing task among a set of image-processing tasks the PINOBL model is configured to perform;
determining attributes based on functional units associated with the input images;
selecting, based on the attributes, physics-based mathematical solvers corresponding to the image-processing task;
generating intermediate images respectively corresponding to the input images, the PINOBL model being associated with the physics-based mathematical solvers;
computing a residual loss based on a comparison between the attributes of the intermediate images and solver parameters associated with the physics-based mathematical solvers;
regenerating the intermediate images based on back-propagation of the computed residual loss until convergence of the attributes with the solver parameters; and
upon convergence of the attributes with the solver parameters, generating final image outputs relating to the image-processing task based on the input images and the intermediate images.

12. The system of claim 11, wherein
the attributes corresponds to a pixel value and temporal information of each of the input images.

13. The system of claim 11, wherein
the indicated image processing task is super-resolution or denoising.

14. The system of claim 11, wherein
the attributes include a brightness value, a contrast, and/or a texture of the input images.

15. The system of claim 11, wherein
the selecting of the physics-based mathematical solvers comprises:
identifying a physics-based laws governing the image-processing task;
selecting physics-based mathematical equations corresponding to the identified physics-based laws; and
constructing a set-up based on the selected physics-based mathematical equations for the input images and based on intermediate image-based substitution, and assessing compliance with the identified physics-based laws.

16. The system of claim 11, wherein
the determining of the attributes based on the functional units comprises:
selecting a functional unit among the functional units based on the indication of the image-processing task;
determining, using the selected functional unit, application-specific images respectively corresponding to the input images; and
determining the attributes based on the application-specific image corresponding to each of the input images.

17. The system of claim 16, wherein the functional unit is selected from available functional units of the PINOBL model, the available functional units including:
a collection of a uniform grid; or
a probability distribution or domain-knowledge/physics-aware sampling.

18. The system of claim 15, wherein
the generating of the intermediate images comprises:
acquiring attribute values of a selected functional unit of the functional units extracted from at least one input image of the input images;
projecting the attribute values on a high-dimensional space; and
performing physics-informed mathematical transformations on the attribute values based on the constructed set-up to generate the intermediate images.

19. The system of claim 18, wherein
the set-up to generate the intermediate images comprises functional blocks with neural network layers.

20. The system of claim 17, wherein
the functional blocks comprise at least one fully connected layer block and a Fourier block with a skip connection.
